(19) United States
(12) Patent Application Publication
(10) Pub. No.: US 2012/0274461 A1
(43) Pub. Date: Nov. 1, 2012

(54) DEVICE FOR MONITORING A VEHICLE WHEEL AND CORRESPONDING COMMUNICATION METHOD

(76) Inventors: Paolo Colombo, Alessandria (IT); Domenico Cantarelli, Pecetto di Valenza (Alessandria) (IT)

(21) Appl. No.: 13/516,123

(22) PCT Filed: Dec. 15, 2010
(86) PCT No.: PCT/IB10/55844

§ 371 Date: Jun. 14, 2012

(30) Foreign Application Priority Data
Dec. 18, 2009 (IT) TO2009A001003

(51) Int. Cl. B60C 23/04

(52) U.S. Cl. 340/447

(57) ABSTRACT

A device for monitoring a vehicle wheel (1) is provided for:—detecting a value indicating the tyre inflating pressure of a wheel;—converting the value detected into a bit sequence;—associating to each bit sequence, via an encoding, a respective symbol of a pulse-code modulation, where the encoding is such that in the passage between two consecutive symbols of the modulation there is always the variation of just one bit; and—transmitting the symbols of the pulse-code modulation.

### FIELD OF THE INVENTION

The present invention relates to a device for monitoring a vehicle wheel and to a corresponding communication method. More in particular, the invention regards a device that is to be fixed to the wheel of the vehicle and is designed to detect one or more characteristic quantities that can be used for checking tyres, such as for example their pressure, as well as to transmit via radio information representing said quantity or quantities to a receiver device installed on and/or in the body of the vehicle.

The invention has the purpose of guaranteeing, in a simple and economically advantageous way, a high reliability of operation of the monitoring device.

### DESCRIPTION OF THE PRIOR ART

Tyre-monitoring devices for wheels of vehicles are known and usually identified as “tyre-pressure monitoring systems” (TPMSs). Said devices typically comprise a circuit arrangement having a detection part, dedicated to detection of one or more quantities of interest, and a control part, dedicated to processing and transmission of signals. The detection part includes one or more sensors, for detection of one or more quantities to be monitored, typically represented by the inflating pressure and possible other quantities that can affect the operating characteristics of the tyre (such as, for example, ambient temperature, tyre temperature, dry/wet conditions and/or conditions of the road surface). The electrical signals generated by the sensor means are processed by the control part and transmitted thereby to a receiver system set on the body of the vehicle or inside the passenger compartment. The transmission of information from the monitoring device to the receiver system occurs in wireless mode, typically in radiofrequency.

In some TPMS devices the control circuit part is provided with a supply source of its own, comprising one or more miniaturized batteries. In other known TPMS devices the device is, instead, without battery. For this purpose, in some solutions, the circuit part of the device is supplied via a piezoelectric or electromagnetic generator, which exploits the vibrations in the tyre for generating a voltage. In other solutions, the device is instead of a “passive” type, i.e., it is designed so as to react to a specific inductive electromagnetic field produced by a respective reader to supply in response a modulated radiofrequency representing data: hence, since these passive devices do not have any internal energy source, they derive their supply from the electromagnetic field generated by the reader.

In some solutions, the device is fixed on the rim of the wheel, typically integrated in or associated to a retaining valve of the tyre (see, for example the documents US 2003/066343, EP 1524133, U.S. Pat. No. 6,101,870). In other solutions, the device is integrated directly in the body of the tyre, coated with the vulcanized rubber that constitutes it (see, for example, the documents WO 2005/021292, EP0505905).

### AIM AND SUMMARY OF THE INVENTION

The monitoring devices of the type indicated are supplied with low-energy sources, and transmission of information occurs in particularly severe conditions, with consequent risks of communication errors.

The quality of the transmission of information is, for example, affected by the rubber constituting the tyre and/or by metal parts that are located in the area of installation of the monitoring device, which belong to the rim or to the reinforcement structure of the tyre. Consequently, the transmission can be affected by disturbance.

Also adverse environmental conditions—such as high ambient temperature or high tyre temperature, a wet road surface, occasional electromagnetic disturbance, thermal jumps, etc.—can adversely affect the quality of the communication between the device and the corresponding receiver.

Above all, the fact that the transmission occurs between a part that is moving, i.e., the monitoring device mounted on the wheel, and a part that is static with respect to the wheel, i.e., the receiver system mounted on the body of the vehicle, lies frequently at the origin of further errors.

In order to overcome this drawback, in certain solutions the rate of transmission of the information by the device is kept relatively low. This approach, however, determines the loss of transmitted data or packets of data: when the velocity of rotation of the wheel is very high, in fact, a “slow” transmission/reception of the information is markedly affected by errors. On the other hand, the increase in the rate or time of transmission of the information by the monitoring device lies at the origin of other transmission errors, due for example to the marked multipath.

The most widespread technique for guaranteeing a satisfactory quality of communication is hence to use an algorithm of transmission distinguished by a marked redundancy of the data transmitted. This solution, however, has as consequence that the consumption of energy by the device is high, far from suitable both in the case of battery devices and in the case of passive devices, and in any case imposes a certain slowing-down of the communication.

The object of the present invention is basically to overcome the drawbacks outlined previously.

According to the invention, said object is achieved thanks to a monitoring device having the characteristics recalled in the ensuing claims. The invention also regards a corresponding communication method, as well as a computer-program product, which can be loaded into the memory of a computer (for example, a microcontroller or other electronic component, which, in addition to calculation functions, comprises and/or controls also other electronic devices) and comprise parts of software code that can implement the steps of the method when the product is run on a computer. As used herein, the reference to such a computer-program product is understood as being equivalent to the reference to a computer-readable means containing instructions for controlling the processing system to co-ordinate implementation of the method according to the invention.

The annexed claims form an integral part of the technical teaching provided herein in relation to the invention.

### BRIEF DESCRIPTION OF THE DRAWINGS

The invention will now be described, purely by way of non-limiting example, with reference to the annexed plates of drawings, wherein:

FIG. 1 is a schematic perspective view of a monitoring device in accordance with a possible embodiment of the invention;

FIGS. 2 and 3 are schematic perspective views, from different angles, of an example of circuit of the device according to the invention;

FIG. 4 is a block diagram of an embodiment of a transmission system according to the invention;

FIGS. 5-12 are diagrams aimed at illustrating the transmission scheme used in embodiments of the invention;

FIG. 13 is a circuit diagram of a possible embodiment of the device according to the invention; and

FIG. 14 is a state-transition diagram that shows a possible embodiment of the control scheme used in the device according to the invention.

### DETAILED DESCRIPTION OF EMBODIMENTS OF THE INVENTION

The ensuing description illustrates various specific details aimed at an in-depth understanding of the embodiments. The embodiments can be obtained without one or more of the specific details, or with other methods, components, materials, etc. In other cases, known structures, materials, or operations are not illustrated or described in detail so that various aspects of the embodiments will not be obscured.

Reference to “an embodiment” or “one embodiment” in the framework of the present description indicates that a particular configuration, structure, or characteristic described in relation to the embodiment is comprised in at least one embodiment. Hence, phrases such as “in an embodiment” or “in one embodiment”, which may be present in different points of this description, do not necessarily refer to one and the same embodiment. Furthermore, particular conformations, structures, or characteristics can be combined in any adequate way in one or more embodiments.

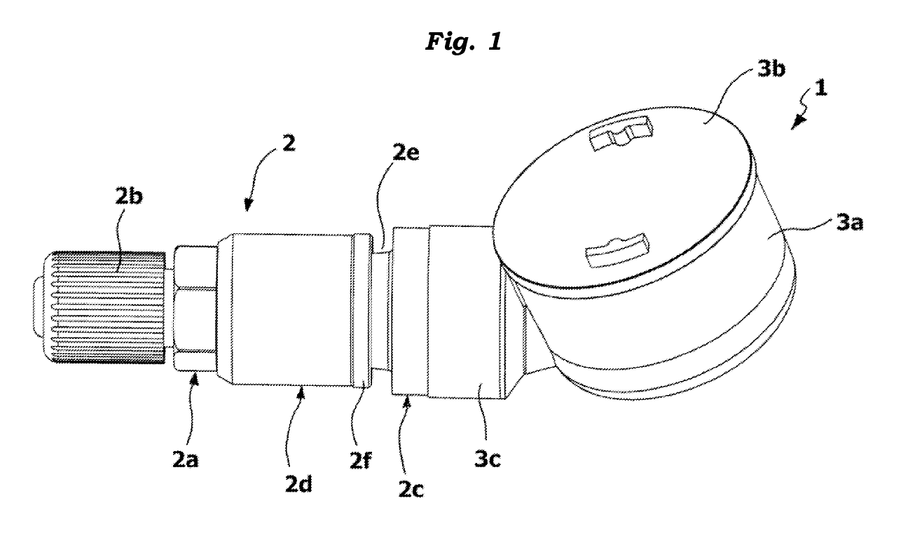

In FIG. 1, designated as a whole by 1 is a device for monitoring a vehicle wheel, according to a possible embodiment of the invention. In the example represented, the device 1 is associated to a valve 2 for inflation and retention of air in the wheel. Preferably, but not necessarily, the device 1 is configured for being coupled in a separable way to the valve 2. The type of assembly illustrated is not to be understood as in any way limiting in so far as the casing of the device according to the invention could have a shape different from the one exemplified and be coupled, in a way independent of a valve, to other parts of the wheel, in a separable way or otherwise, for example on the rim of the wheel or to a tyre thereof.

The valve 2, which is basically of a known type, comprises a main body 2a made of electrically conductive material, such as a metal, with an internal duct for the passage of air (not visible). The proximal end of the body 2a is externally threaded, so that a cap 2b can be screwed thereon. Also the distal end of the body 2a is externally threaded such that a spacer member 2c, of an annular shape, preferably made of synthetic and electrically insulating material, can be screwed thereon. The body 2a has an external thread also in its intermediate region, so that an assembly casing 2d, which is axially hollow and is made, for example, of plastic or metal material, can be screwed thereon. In the assembled condition of the components of the valve 2 indicated above, the member 2c and the casing 2d define between them an annular seat 2e, at which a seal ring or gasket 2f is preferably provided, made in particular of electrically insulating synthetic material.

The valve 2 is to be mounted at a through hole of the rim of the wheel, not represented. Insertion of the valve 2 is such that the distal end of the body 2a with the member 7 are located inside the rim, or in the channel for mounting the tyre, whilst the remaining part of the body 2a is located for mostly on the outside of the rim. Following upon said insertion, moreover, the axial duct of the body 2a is in fluid communication with one or more radial ducts (not visible), defined between the body 2a itself and the member 2c.

For the purposes of installation, screwed on the body 2a of the valve 2 is the spacer member 2c, as represented, and the assembly thus formed is inserted in the aforesaid hole of the rim, from inside the channel for mounting the tyre, until the member 2c comes to bear upon the internal surface of the rim. On the intermediate threaded region of the body 2a, from the outside of the rim, the gasket 2f is then inserted, which bears upon the external surface of the rim, and is then screwed right down in the casing 2d. In this way, the region of the rim that surrounds the hole for insertion of the valve 2 is gripped between the member 2c and the gasket 2f, at the seat 2e so as to hold the valve 2 in position.

The valve 2 comprises further internal components, not represented in so far as they are in themselves known, such as open/close means and a valve stem configured for obtaining a retaining valve and/or enabling one-way passage of the air in the axial duct of the body 2a and then in the aforesaid radial ducts, towards the inside of the channel for mounting the tyre, so that the tyre can be inflated.

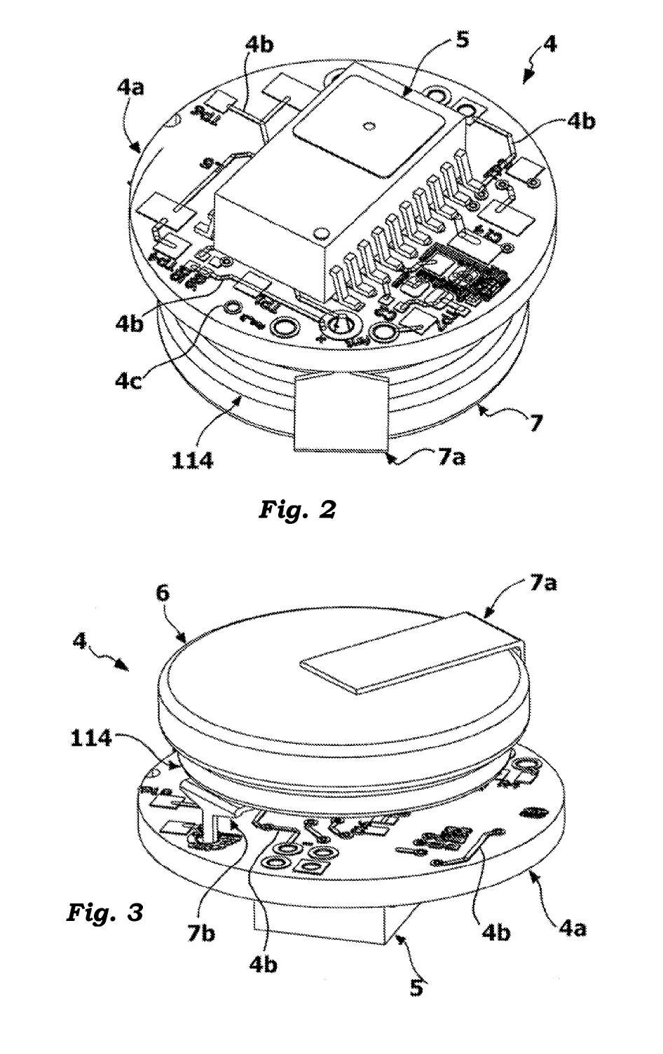

In the embodiment exemplified, the device 1 has a casing comprising a main body 3a and a lid 3b, which are mutually coupled for defining a housing for a circuit, designated as a whole by 4 in FIGS. 2 and 3. The casing body 3a is prevalently made of a relatively rigid mouldable plastic material, preferably of a piece single. Also the lid 3b is preferably made of a mouldable plastic material, preferably relatively rigid. The casing body 3a defines an attachment part 3c, for connection of the casing of the device 1 to the valve 2. The physical connection between the part 3c and the valve 2 can occur with any known modality and means, for example with a snap-action engagement or with means of a threaded type.

In the example represented, the circuit 4 comprises a circuit support 4a, or PCB, made of insulating material, for example fibreglass, typically known by the name FR4, mounted on which arc electrical and electronic circuit components, amongst which at least one sensor means for detecting a quantity characteristic of the wheel status. In the example of embodiment described, the information generated and transmitted by the device 1 regards at least the tyre inflating pressure. In possible variants of the invention, in addition or as an alternative to the detection of the pressure, the device 1 can be configured for detecting and transmitting values representing other quantities useful for monitoring the tyre, such as, for example, the temperature of the tyre, the stresses or vibrations produced during movement thereof, the acceleration according to one or more axes, etc., using for said purpose sensor means of a type in itself known.

Consequently, in a preferred embodiment, the circuit 4 comprises a pressure sensor 5, in particular a sensor of an absolute type, preferably made of semiconductor material. It should be noted that, in order to enable detection of pressure by the sensor 5, the part of casing 3a is provided with a through hole, not visible in FIG. 1.

The circuit arrangement provided on the support 31 includes means for processing and/or conditioning the signal generated by the corresponding sensor means, such as the sensor 5, as well as a transmission circuit (possibly for transmission and reception), in particular for at least transmitting the corresponding pressure information in wireless mode, in particular in radiofrequency, to a receiver system, not represented. The transmission means include an antenna, designated by 114, basically constituted by a metal wire. In accordance with one embodiment, the device 1 can be provided also for receiving data, for example, programming and/or configuration data, from an external transmitter, not necessarily represented by a control unit of the monitoring system installed on board the vehicle. Consequently, in said embodiment, the circuit arrangement also comprises reception means. The transmission and reception means can be conveniently implemented by one and the same transceiver device.

The circuit 4 further includes a supply source, represented by a button-cell battery 6, as well as contact elements, designated by 7a and 7b, connected to the circuit arrangement mounted on the support 4a, for supply thereof. In the example considered, the battery 6 is a 3-V battery. In embodiments alternative to the one represented, the battery is omitted, and the circuit part of the monitoring device is supplied via a piezoelectric or electromagnetic generator, which exploits the vibrations in the tyre or of the wheel.

The circuit support 4a is provided with electrically conductive paths 4b, of a type in itself known. In one embodiment, one of said conductive paths, not visible in FIGS. 2-3, terminates, at a respective end, in a position corresponding to a hole, designated by 4c in FIG. 2, formed passing through the support 4a. At said hole 4c, the path in question is preferably pad-shaped or ring-shaped or shaped like a bushing in order to surround the hole itself or coat surfaces that delimit it. This hole 4c can be used for electrically coupling the circuit 4 to a metal terminal, which electrically connects the circuit 4 to the metal body 2a of the valve 2, passing through the attachment part 3c. In this embodiment, in order to improve the radio frequency transmission of the signal generated by the device 1, from inside the wheel outwards, the device itself is built so as to constitute a so-called monopole, with a configuration substantially of the type known as “single ground stub”. Said monopole is formed by the radiant element constituted by the antenna 114 of the device 1 (which is located within the tyre) and the body 2a of the valve 2, which, in the installed condition, extends for the most part on the outside of the tyre. Hence, in said embodiment the body 2a of the valve 2 has a part that is active in transmission of the signal, and in particular constitutes the ground stub of the monopole, with the hole 4c and the aforesaid terminal that enable a galvanic connection to be obtained between the circuit 4 and the valve body 2a. In order to match the impedance of the transmission stage to that of the antenna, the circuit 4 is preferably provided with an impedance-matching network, connected to the conductive path that terminates at the hole 4b.

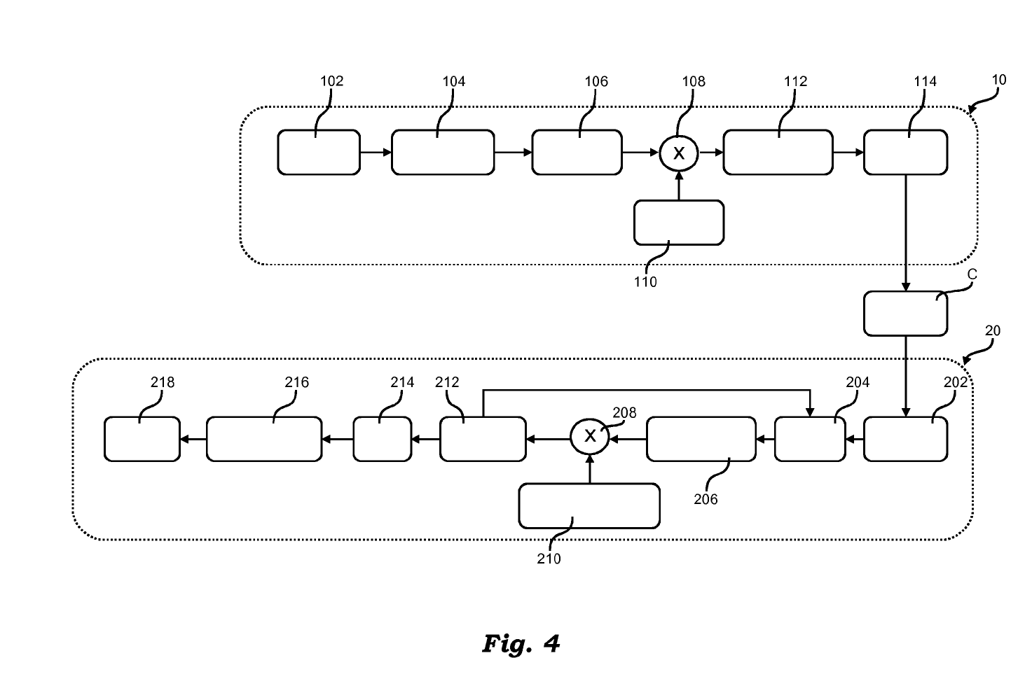

FIG. 4 shows an embodiment of the communication system, comprising a transmitter 10, belonging to the device 1, and a receiver 20, mounted on or in the body of the vehicle, which are connected via a communication channel C.

In various embodiments, the transmitter 10 comprises a data source 102, which generates a sequence of bits. The bit sequence is supplied to a modulator 104, which carries out the modulation of the signal, where by “modulation” is meant the technique of transmission of an electromagnetic signal, referred to as “modulating signal”, possibly representing information, by means of another electromagnetic signal, referred to as “carrier”, which has the purpose of transmitting the information at high frequency. The digital-signal modulation techniques most commonly adopted are amplitude-shift-keying (ASK) digital modulation, frequency-shift-keying (FSK) digital modulation, and phase-shift-keying (PSK) digital modulation.

Purely by way of example, the modulator 104 can implement a particular form of PSK, known as “pulse-code modulation” (PCM).

In greater detail, in an embodiment currently deemed preferential, described here, the modulator 104 is of a pulse-position-modulation (PPM) type. Preferably, a 16 PPM modulator is used (with encoding system 1 out of 16, hence with one frame to be sent, which is divided into as many symbols or nibbles of 16 bits each). Not ruled out is in any case the possibility of using a different PCM or PPM encoding, such as for example 1 out of 256 (hence, for example, with a 256 PPM modulator).

The modulator 104 generates respective transmission symbols, calculating the timings for the pulses to be transmitted on the radio channel according to the specifications indicated hereinafter.

For example, in the case of PPM, the modulator 104 can calculate the timings for the pulses to be transmitted on the transmission channel C.

In various embodiments, the generation of the transmission signal is obtained by a module 106, which combines in a combiner 108 the transmission symbols (or low-frequency pulses) with a high-frequency carrier signal. The carrier signal can be, for example, supplied by an oscillator 110, e.g., a 315-MHz or 433-MHz oscillator. Preferably, the oscillator 110 is a quartz oscillator. The use of a said type of oscillator affords a high frequency stability, guaranteed by the quartz and by the possibility of calibrating easily the carrier frequency through a digital circuit of a phase-locked-loop (PLL) type.

In various embodiments, in order to generate the transmission signal, the module 104 generates directly low-frequency pulses, and the module 106 opens and closes for a respective time window the high-frequency carrier signal in such a way as to generate respective series of transmission pulses or bursts. The duration of the bursts is hence determined by the duration of the low-frequency pulses.

In various embodiments, said transmission signal (comprising a plurality of bursts) is transmitted via the antenna 114. The transmitter 10 can also comprise further elements 112, for example a bandpass filter for filtering and/or a power amplifier for amplifying the transmission signal. For example, the bandpass filter can ensure that the transmission bursts are signals of a sinusoidal shape.

In various embodiments, the receiver 20 comprises an antenna 202 for receiving the signal transmitted by the transmitter 10.

In various embodiments, the signal received is amplified by an amplifier 204 and filtered by a bandpass filter 206.

In various embodiments, the filtered signal is combined in a combiner 208 with a high-frequency carrier signal, for recreating the transmitted symbol (or the low-frequency pulses). For example, the carrier signal can be supplied by an oscillator 210, for instance, an oscillator having a frequency of oscillation typically lower than that of the carrier of a frequency referred to as “Intermediate Frequency”. One of the typical values of the Intermediate Frequency is 10.7 MHz, the frequency generated by the oscillator 210 thus being 433−10.7=422.3 MHz.

In various embodiments, the low-frequency pulse is next supplied to a pulse detector 212 and then to an Analog-to-Digital Converter 214 (ADC), for carrying out subsequent de-modulation of the pulse via a digital circuit, for example, a micro-processor.

The pulse detector 212 is basically constituted by a circuit designed to generate at its own output a high signal when the signal at its input has a value significantly higher than the background noise, whereas it generates at its own output a low signal when the signal sent at its input has a value comparable to the background noise.

In various embodiments, the pulse is processed by a de-modulator 216, for example a 16 PPM de-modulator to de-modulate the PPM symbol transmitted and generate again the transmitted bit sequence 218.

In the embodiment considered, the amplifier 204 is preferably a Low-Noise Amplifier (LNA) with automatic gain control. In this case, it may be envisaged that the pulse detector 212 supplies feedback information for appropriately setting the amplification of the amplifier 204.

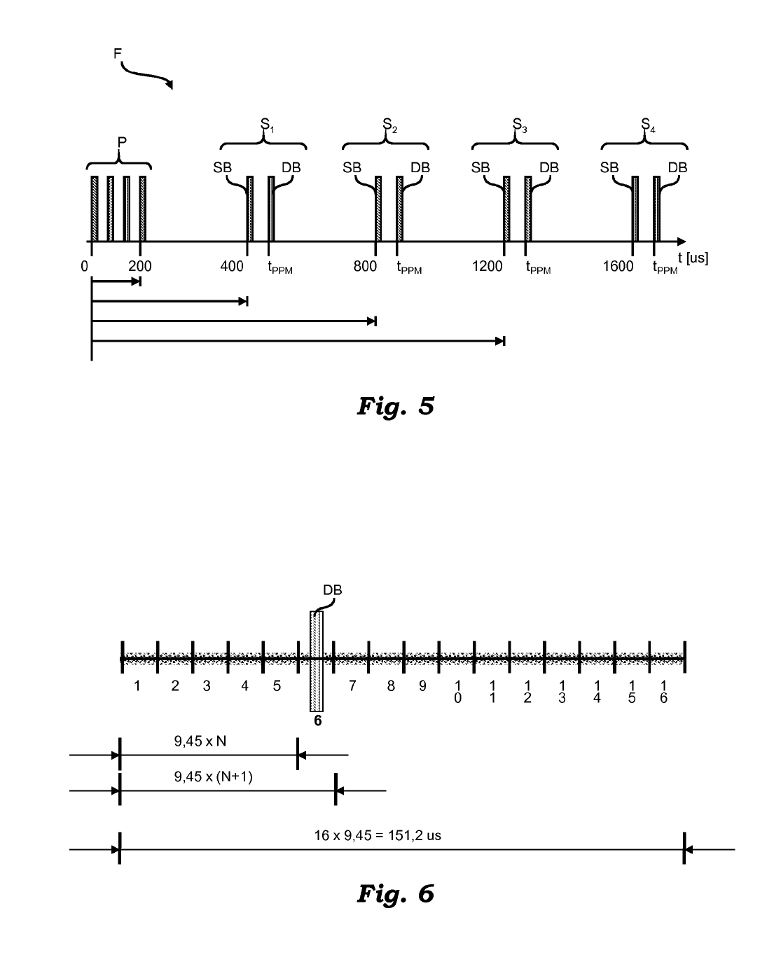

FIG. 5 shows a possible embodiment of a transmission sequence or frame F.

The frame F comprises a preamble P, constituted by a series of pulses (or bursts). For example, the preamble P enables identification of a new transmission frame F and helps to set the thresholds of the receiver 20 (for example, the amplification of the amplifier 204). For instance, said preamble P can comprise from 4 to 8 bursts.

Next, the transmitter generates successions of bursts in order to transmit the encoded symbols S. For example, each of the symbols S₁, S₂, S₃, S₄, etc., can comprise a start burst SB and a data burst DB.

In various embodiments, each symbol S has a duration of 400 μs, and the data burst DB of a symbol follows the start burst SB with a delay of t_{PPM}.

In various embodiments, the time t_{PPM} defines the PPM symbol. FIG. 6 shows a possible relation between the time t_{PPM} and a 16 PPM symbol.

Associated to each PPM symbol is a time interval with a duration preferably comprised between 5 and 15 μs. In the embodiment considered, associated to each PPM symbol is a time interval of 9.45 μs, and the entire interval useful for transmission of the data burst DB is hence 16×9.45 μs=151.2 μs.

For example, FIG. 6 illustrates the transmission signal for the symbol N=6, in which the data burst DB is transmitted in the time interval between 6×9.45 μs (i.e., N×9.45 μs) and 7×9.45 μs (i.e., (N+1)×9.45 μs).

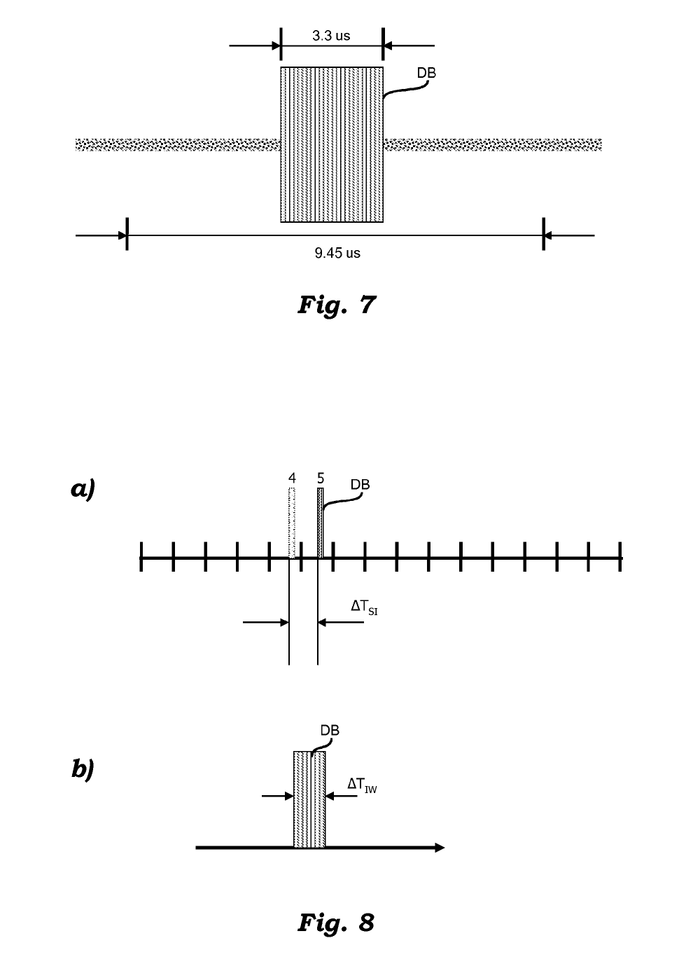

The duration of a data burst DB is preferably comprised between 1 and 5 μs. FIG. 7 shows a possible embodiment of a data burst DB that has a duration of 3.3 μs and is transmitted in a time interval of 9.45 μs.

A person skilled in the branch will appreciate that the reliability of the transmission system depends above all upon the error on the timing of the pulses.

By way of example, FIG. 8a shows a first source of error that acts on the initial instant of the individual pulses. For example, the transmitter can transmit the symbol N=5 but, as a result of the noise introduced, the symbol is shifted in time by a quantity AT such that the pulse occupies the temporal position associated to the symbol N=4. Said error is typically gaussian, with zero mean and standard deviation σ_{SI}:

ΔT˜N(0, σ_{SI})

Once again by way of example, FIG. 8b shows a second source of error that acts on the temporal width of the pulse detected by the pulse detector 212. Said error is typically gaussian, with mean μ_{IW} and standard deviation σ_{TW}:

ΔT˜N(μ_{TW}, σ_{TW})

The negative effect introduced by this second source of error is linked to the possibility of obtaining a signal in which the pulses are very short in time so that the decoder is unable to detect them correctly.

These sources of errors hence affect the performance of the communication system, which are frequently measured in terms of:
a) Frame-Error Rate (FER);
b) Symbol-Error Rate (SER); and
c) Bit-Error Rate (BER).

In various embodiments, to optimize the performance and reliability of the transmission system, the time window associated to the symbol must be sufficiently wider than the width of the burst of pulses of the symbol itself, so as to leave a wider margin as compared to the error introduced in the temporal shift of the pulses.

In various embodiments, to prevent collision between the packets coming from a plurality of transmitters, each transmission packet is made up of a plurality of transmission frames F. In particular, the frame F itself is repeated after a random time interval.

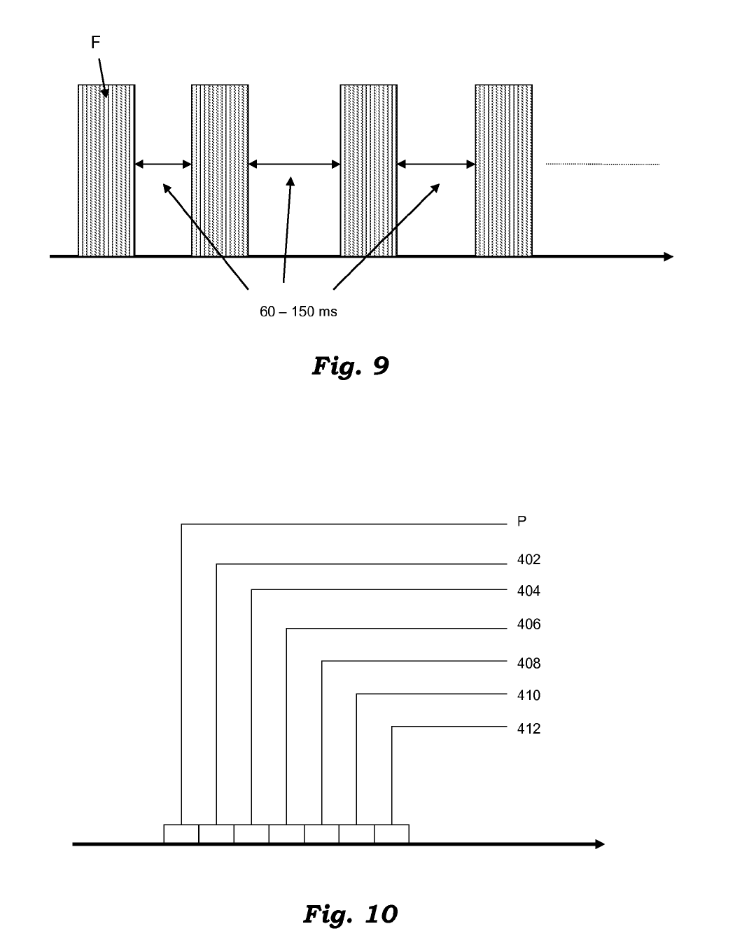

For example, FIG. 9 shows an embodiment of a transmission packet comprising a frame F that is repeated four times after a time interval randomly chosen between 60 and 150 ms. However, to accelerate transmission, the frame F could also be repeated only twice after a time interval chosen randomly, for example, between 60 and 90 ms.

FIG. 10 shows an embodiment of the transmission protocol used within a frame F.

In the embodiment considered, the frame starts with a preamble P followed by a plurality of data byte and a correction code that enables verification of the integrity of the data, for example a checksum.

For instance, in the embodiment considered, the preamble P consists of 8 bursts followed by 7 data bytes comprising:
32 bits for a code 402 that identifies the transmitter;
8 bits for the value of the pressure 404, detected by the sensor 5;
8 bits for a value 406 of another characteristic quantity detected by a corresponding sensor, for example, a temperature value, detected by a suitable sensor of the circuit 4, which can be used for example for compensating the pressure value;
4 bits for the value 408 of the voltage of the battery 6, detected by the circuit 4 in a way in itself known; and
4 bits for a count value 410 (for example, the number of frames within the transmission packet).

In the embodiment considered, at the end of the frame F also 8 bits for a checksum 412 are transmitted.

A simple checksum is effective if the bit sequence includes only a few errors. As explained in the introductory part of the present description, however, the monitoring devices of the type considered herein are subject to particularly severe conditions of use, with consequent risks of major communication errors.

The inventors have noted that the bit error can be advantageously reduced if, for the purposes of mapping of the bit sequence into symbols of the 16 PPM modulation, an encoding is used designed to guarantee that in the passage between two consecutive symbols there is always the variation of just one bit, as envisaged according to Gray encoding.

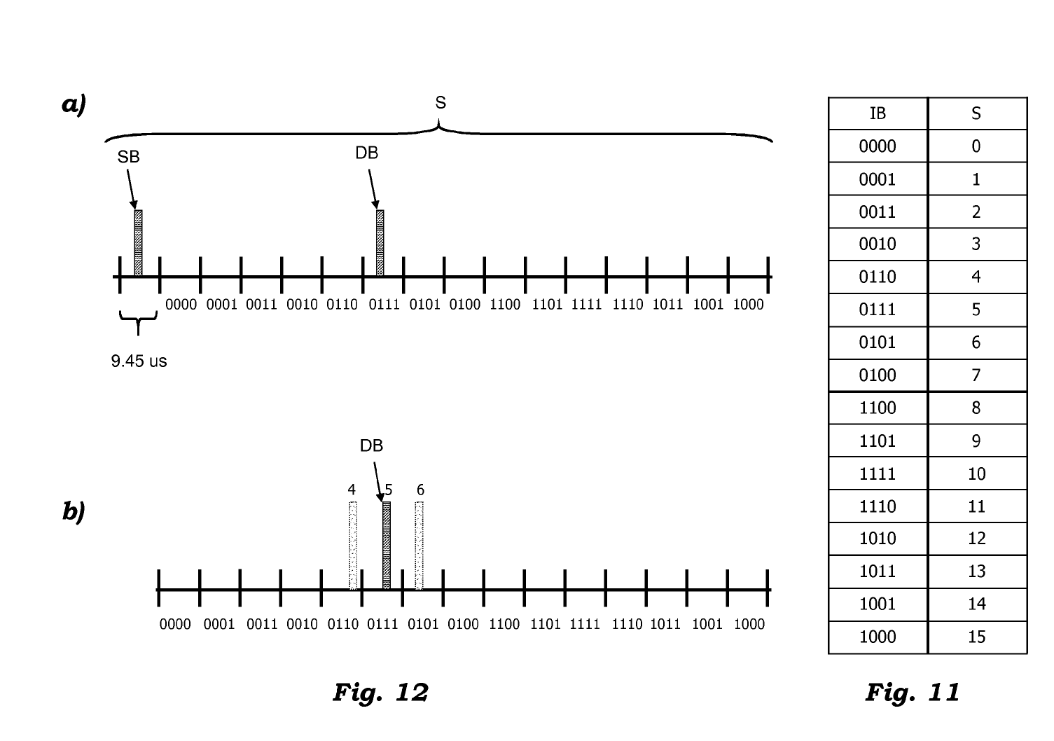

For example, FIG. 11 shows a possible embodiment of such a mapping. In particular, FIG. 11 shows a table that represents the relation between a sequence of four bits at input IB and the respective symbol S of the 16 PPM modulation. As may be noted, adjacent symbols all differ by just one bit.

This enables on the one hand marked reduction of the BER and also of the SER, because a possible error can be corrected during reception by applying a channel encoding.

FIGS. 12a and 12b shows in detail the advantage of the encoding indicated above.

In particular FIG. 12a, shows the transmission signal for a bit sequence “0111”.

According to the encoding provided in accordance with the invention, this bit sequence corresponds to the symbol N=5, i.e., the transmission signal comprises a start burst SB followed by a data burst DB in the fifth time interval.

For example, as a result of multipath and/or of other than optimal temporal synchronisation of the receiver 20, the receiver can receive the adjacent symbols, i.e., the symbol N=4 or the symbol N=6 (see FIG. 10b).

In the case where the receiver receives the symbol N=4, corresponding to the bit sequence “0110”, the error is only of just one bit. Also in the case where the receiver receives the symbol N=6, corresponding to the bit sequence “0101”, the error is only of just one bit.

Said error can be detected easily via the correction code and possibly even corrected. In general, in numerical transmissions, it is possible to introduce a redundancy in the transmitted sequence, by sending more symbols than those produced by the source. Said additional symbols are chosen so as to be in some way dependent upon one another, and this enables the receiver to detect possible errors, in so far as the dependence envisaged is no longer respected. The redundancy introduced can be used to correct the error, request re-transmission of the symbol, or simply discard the frame transmitted.

Instead, with a binary encoding, the transmitter would transmit the symbol N=7 for the bit sequence “0111”. Once again as a result of multipath and/or of other than optimal temporal synchronisation of the receiver, the receiver could receive the adjacent symbols, i.e., the symbol N=6 or the symbol N=8. In the case where the receiver receives the symbol N=6, corresponding to the bit sequence “0110”, the error is of just one bit. Instead, in the case where the receiver receives the symbol N=8, corresponding to the bit sequence “1000”, the error would increase to four bits.

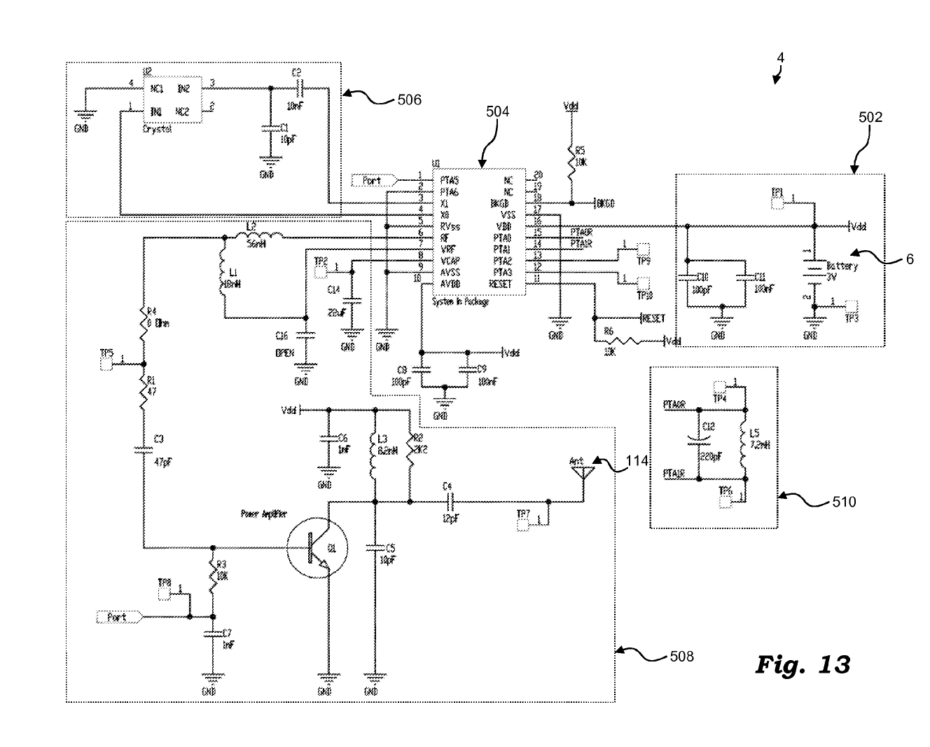

The advantages of the encoding system proposed are consequently evident. FIG. 13 shows a circuit diagram of a possible embodiment of a transmitter 10 that can be used in the circuit 4 of a device 1 according to the invention.

In the embodiment considered, the core of the circuit 4 is a system of the type known as “System-In-Package” (SIP), designated as a whole by 504, which comprises:
one or more sensors, such as the pressure sensor 5, for detecting the pressure of a tyre, a temperature sensor and/or an acceleration sensor, for example a triaxial acceleration sensor for detecting the acceleration along the axes X, Y, and Z;
a micro-controller for processing analog and digital signals; and
a continuous-wave generator, for example a low-power PLL wave generator, for generating the carrier signal.

In various embodiments, the circuit 4 comprises a supply source 502 for supplying a supply signal (VDD), for example, the battery (“Battery”) 6, with a respective filtering circuit (C10 and C11). For example, the system 504 can also comprise a supply circuit, for example a step-up or step-down converter for converting the voltage of the battery 6 into a stable voltage used by the micro-processor.

In various embodiments, the system also comprises an oscillator 506 (“Crystal” in FIG. 13, with corresponding filtering components C1 and C2) for supplying the clock signal for the micro-processor, and a circuit 508 for high-frequency transmission.

In various embodiments, the circuit 508 comprises the antenna 114 (“Ant”) for ultra-high-frequency (UHF) transmission, for example at 433/315 MHz, and a power amplifier (“Power Amplifier” in FIG. 13) with corresponding impedance-matching circuit (L1, L2, R1, C3, L3, C5, C4, etc.).

In various embodiments, the micro-controller contained in the System-In-Package 504 receives the data measured by the sensor means provided, for example the pressure sensor 5, and generates the low-frequency pulses for the transmission of 16 PPM symbols. In particular, the micro-processor can generate the pulses for the preamble P, and for each symbol S a start pulse and the respective data pulse. In a possible embodiment, the carrier signal is generated by the SIP 504 and sent to the power amplifier via the output “RF”, whilst a second signal “Port” is used for opening and closing the time window of the carrier signal in such a way as to generate respective series of transmission pulses or bursts, which are transmitted via the antenna 114.

In various embodiments, the system also comprises a low-frequency (LF) communication interface 510, for example a low-frequency oscillator circuit (e.g., 125 kHz) comprising a capacitor (C12) and an inductance (L5). Said interface 510 can be used, for example, for receiving commands from an external control interface.

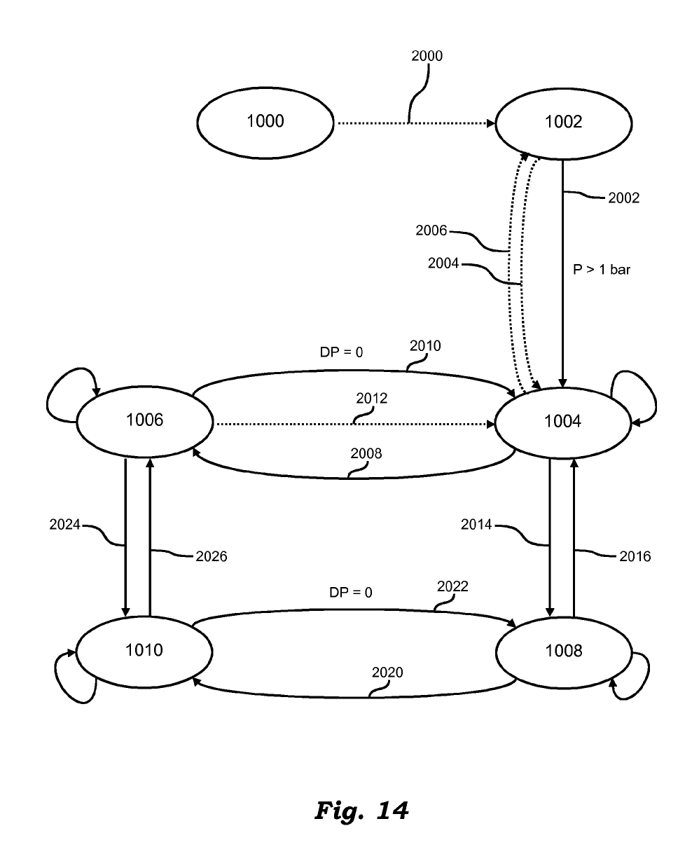

FIG. 14 shows a flowchart of an embodiment of the control scheme used within the micro-controller of the system 504.

At start, the system is in an off state 1000.

When the supply of the circuit 4 is activated or when activation is requested via a command received from the interface LF, the system, via a transition 2000, goes into a state of inactivity 1002.

In the state of inactivity 1002, the system monitors, for example every 30 s, the pressure of the tyre and when a pressure threshold, for example 1 bar, is exceeded the system goes, via a transition 2002, into a parking state 1004.

The system can also make a transition into the state 1004 if an activation command 2004 is received from the interface LF. The system can also return into the state of inactivity 1002 if a deactivation command 2006 is received from the interface LF.

In the parking state 1004, the system regularly monitors the pressure, for example every 30 s, and possibly transmits the respective data. The system exits from the parking state 1004 if the vehicle starts to move or if the pressure measured undergoes a considerable change, for example +−10 kPa from the last value measured.

In particular, if the system detects a considerable change in the pressure of the tyre, it proceeds via a transition 2008 to an alarm state 1006.

In the alarm state 1006, the system controls the pressure of the tyre more frequently, for example every second, and the data are transmitted, for example every 8 s.

The system returns, via a transition 2010, into the parking state 1004 if the pressure of the tyre returns to the initial value, for example if the difference between the pressure measured and the pressure measured in the previous instants becomes substantially equal to zero (DP=0), this being a sign that the pressure is stabilized.

The system can also return, via a transition 2012, into the parking state 1004 if a command is received from the interface LF.

The system carries out instead a transition 2014 into a movement state 1008 if it detects that the vehicle starts to move, for example through a measurement of the acceleration in the direction Z, detected by a corresponding sensor.

In the movement state 1008, the system regularly monitors the pressure, for example every 10 s, and transmits the respective data, for example every 30 s. The system exits from the movement state 1008 if the vehicle stops or if the pressure undergoes a change deemed significant, for example +−10 kPa from the last value measured.

In particular, if the system detects a significant change in the pressure of the tyre, via a transition 2020 it goes into an alarm state 1010, in which it controls more frequently the pressure of the tyre, for example every second, and the data are transmitted, for example, every 8 s.

The system returns via a transition 2022 into the movement state 1008 only if the pressure of the tyre returns to the initial value, for example if the difference of the pressure measured returns to the normal pressure (DP=0).

The system returns instead, via a transition 2016, from the movement state 1008 to the parking state 1004 Wit detects that the vehicle has stopped.

In the embodiment considered, also two further transitions 2024 and 2026 are envisaged between the alarm states 1006 and 1010, so as to change state when the fact that the vehicle starts to move and the fact that it has stopped in one of the alarm states 1006 or 1010 arc, respectively, detected.

The type of PPM modulation indicated as preferential guarantees a very low average consumption during transmission by the device 1 (average current 1 mA for 10 ms). In stand-by mode, the consumption of the device is lower than 350 nA. Thanks to the low consumption levels, the device 1 can function also when the vehicle is parked, with a low transmission rate. In this way, a service life of the battery, for example a 3-V battery, variable between seven and ten years is ensured.

The on-board control unit of the monitoring system is clearly configured for receiving the values measured by the transmitter 10 of the device 1. In one embodiment said control unit hence comprises:
means for receiving the symbols of the modulation transmitted by the device 1;
means for associating to each symbol of the modulation, via a decoding, a respective bit sequence, wherein the associating means are configured in such a way that in the passage between two consecutive symbols of the modulation there is always the variation of just one bit; and
means for detecting in the bit sequence the aforesaid values measured, such as the value of the inflating pressure of the tyre, temperature thereof, etc.

As mentioned previously, in one embodiment, the device 1 is provided for transmitting and receiving data. In said embodiment, the device 1 can include a receiver stage equivalent to the one designated by 20 in FIG. 3, with Gray encoding. At the other end, a transmitter circuit equivalent to the one designated by 10 is provided on board the vehicle. In this embodiment, the transmission between the aforesaid transmitter on board the vehicle and the device 1 occurs according to the methodology described previously with reference to the transmission from the stage 10 to the stage 20. In said embodiment, the monitoring device 1, which is in any case configured for detecting and transmitting information regarding at least one characteristic quantity of the wheel status, comprises:
means for receiving symbols of a pulse-code modulation;
means for associating to each symbol of the pulse-code modulation, via a decoding, a respective bit sequence, wherein the associating means are configured in such a way that in the passage between two consecutive symbols of said modulation there is always the variation of just one bit; and
means for detecting in the aforesaid bit sequence the data transmitted by the control unit or other external device.

As mentioned previously, these data can be, for example, commands, programming data and/or configuration data, coming from the on-board control unit or from an external transmitter.

In said embodiment, moreover, the transmitter and receiver circuits of the device 1 and of the corresponding control unit mounted on board the vehicle (or other external transmitter) preferably each come under a single respective antenna, both for transmitting and for receiving.

Of course, without prejudice to the principle of the invention, the details of construction and the embodiments may vary, even significantly, with respect to what has been illustrated herein purely by way of non-limiting example, without thereby departing from the scope of the invention, as defined by the annexed claims.

1. Device for monitoring a vehicle wheel, configured for detecting and transmitting to a receiver, by a wireless connection (C), information relating to at least one characteristic quantity of the wheel status, such as the inflation pressure of a wheel tyre, the device comprising:
at least one sensor for detecting at least one value indicative of the said characteristic quantity, such as the tyre inflation pressure,
means for converting said at least one value into a sequence of bits (IB),
means for associating to each sequence of bits (IB), by means of a coding, a respective symbol (S) of a pulse-code modulation, wherein said means for associating are configured such that a single bit change occurs when passing between two consecutive symbols (S) of said modulation,
means for transmitting said symbol (S) of said pulse-code modulation.

2. Device according to claim 1, wherein said pulse-code modulation is a pulse-position modulation, such as for example a 16 PPM or a 256 PPM pulse-position modulation.

3. Device according to claim 1, wherein said means for transmitting said symbols (S) of said modulation comprise:
means for converting each symbol (S) into a low frequency pulse sequence, preferably comprising a start pulse (SB) and a data pulse (DB) wherein the time interval between said start pulse and said data pulse is determined based on said symbol (S).

4. Device according to claim 3, wherein
a time interval having a length comprised between 5 and 15 microseconds, particularly about 9.45 microseconds, is associated to each symbol (S); and
the length of said data pulse (DB) is comprised between 1 and 5 microseconds, particularly about 3.3 microseconds.

5. Device according to claim 3, wherein said means for transmitting said symbols (S) of said modulation comprises:
a generator for generating a high frequency carrier signal, and
a circuit for creating transmission pulse series or burst (SB, DB) by combining said low frequency pulse sequence with said high frequency carrier signal.

6. Device according to claim 5, wherein said generator comprises an oscillator, particularly a quartz oscillator.

7. Device according to claim 1, wherein said means for transmitting said symbols (S) of said modulation are configured for transmitting said symbols (S) by means of a transmission frame (F) comprising a preamble (P) identifying a new transmission frame (F) followed by said symbols (S).

8. Device according to claim 7, wherein
said transmission frame (F) comprises a correction code, and/or
said means for transmitting said symbols (S) are configured for transmitting said transmission frame (F) at least twice, with a randomly chosen time interval.

9. Device for monitoring a vehicle wheel, configured for receiving data from a transmitter, comprising:
means for receiving symbols (S) of a pulse-code modulation,
means for associating to each symbol (S) of said pulse-code modulation, by means of a coding, a respective sequence of bits, wherein said means for associating are configured such that a single bit change occurs when passing between two consecutive symbols (S) of said modulation, and
means for detecting said data in said sequence of bits.

10. System for monitoring a vehicle wheel, comprising
a first device configured for detecting and transmitting, by a wireless connection (C), information relating to at least one characteristic quantity of the wheel status, such as the inflation pressure of a wheel tyre,
a second device configured for receiving, by a wireless connection (C), the information relating to the at least one characteristic quantity of the wheel status,
the first and the second device each comprising at least one of a transmission circuit arrangement and a reception circuit arrangement, wherein
the transmission circuit arrangement comprises:
means for converting data to be transmitted into a sequence of bits (IB),
means for associating to each sequence of bits (IB), by means of a coding, a respective symbol (S) of a pulse-code modulation, wherein said means for associating are configured such that a single bit change occurs when passing between two consecutive symbols (S) of said modulation,
means for transmitting said symbol (S) of said pulse-code modulation,
the reception circuit arrangement comprises:
means for receiving symbols (S) of a pulse-code modulation,
means for associating to each symbol (S) of said pulse-code modulation, by means of a coding, a respective sequence of bits, wherein said means for associating are configured such that a single bit change occurs when passing between two consecutive symbols (S) of said modulation,
means for detecting data to be received in said sequence of bits.

11. Method for communicating through a wireless connection (C) information relating to at least one characteristic quantity of the status of a vehicle wheel, such as the inflation pressure of a wheel tyre, the method comprising:
detecting at least one value indicative of the said characteristic quantity, such as the tyre inflation pressure,
converting said at least one value into a sequence of bits,
associating to each sequence of bits (IB), by means of a coding, a respective symbol (S) of a pulse-coded modulation, wherein said coding is such that a single bit change occurs when passing between two consecutive symbols (S) of said modulation, and
transmitting said symbols (S) of said pulse-code modulation.

12. Method according to claim 11, wherein said pulse-code modulation is a pulse-position modulation, such as for example a 16 PPM or a 256 PPM pulse-position modulation.

13. Method according to claim 11, comprising the operation of converting each symbol (S) into a low frequency pulse sequence preferably comprising a start pulse and a data pulse, wherein the time interval between said start pulse and said data pulse is determined based on said symbol (S).

14. Method according to claim 13, comprising
generating a high frequency carrier signal by means of a quarts oscillator, and
creating transmission pulse series or burst (SB, DB) by combining said low frequency pulse sequence with said high frequency carrier signal.

15. A computer program product loadable into the memory of a computer and including software instructions or code portions adapted for performing the steps of the method of claim 11 when the product is run on a computer.
